(19) United States
(12) Patent Application Publication
(10) Pub. No.: US 2017/0338535 A1
(43) Pub. Date: Nov. 23, 2017

(54) PORTABLE BATTERY MODULE CONTROLS AND THERMAL MANAGEMENT

(71) Applicant: Nilesh Gajanan BHOIR, San Diego, CA (US)

(72) Inventor: Nilesh Gajanan BHOIR, San Diego, CA (US)

(21) Appl. No.: 15/597,770

(22) Filed: May 17, 2017

Related U.S. Application Data
(60) Provisional application No. 62/338,894, filed on May 19, 2016.

(51) Int. Cl. H01M 10/6572; H01M 2/10; H01M 10/6551; H01M 10/48; H01M 10/647

(52) U.S. Cl. CPC H01M 10/6572; H01M 10/486; H01M 10/482; H01M 10/647; H01M 10/6551; H01M 2/1077

(57) ABSTRACT

The present disclosure relates to a portable, light weight, and swappable battery module/system comprising an integrated thermal management system. The integrated thermal management system is light weight and compact in part due to use of a thermoelectric cooler. The management system also allows for incorporation of control systems for application in diverse end uses without the need for different control or thermal management systems.

### FIELD OF INVENTION

The present disclosure relates to the field of thermal management systems for portable battery systems. In particular, the present disclosure provides a light-weight integrated thermal management system for multi-purpose portable rechargeable battery systems wherein the system is light weight and swappable between multiple end applications.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Battery systems or modules exist for various applications such as home use, vehicle use, etc. Each application has its own power and control requirements, particularly thermal management systems, which limits the utility of a particular battery system to a single application. Such systems are complicated and bulky which limit the portability of battery systems.

Thermal management of battery systems is critical for optimum battery function and longevity, apart from user safety.

Therefore, there is a need for developing portable battery systems with integrated control and thermal management systems which is light weight, thus allowing for ease in portability and swapping.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

Some of the objects of the present disclosure, which at least one embodiment herein satisfies are as listed herein below.

An object of the present disclosure is to provide a portable and swappable battery system with onboard integrated thermal management system.

An object of the present invention is to provide a compact thermal management system for use in a portable battery system.

An object of the present invention is to provide a compact thermal management system in a portable battery system for efficient use across a wide range of temperatures and applications.

### SUMMARY OF THE INVENTION

In an aspect of the present disclosure, there is provided a battery system comprising: a plurality of battery cells arranged in a stack; and a thermal management system, wherein the plurality of battery cells are coupled in parallel or in series, and wherein the plurality of battery cells can be attached to at least one fuse or circuit breaker. The battery system of the present disclosure can be configured in a housing unit that comprises a fan, a handle, a heat sink, a charge indicator, and a power connector.

In an aspect, thermal management system can include a first thermally conductive plate, a thermoelectric cooler, an electronic control unit, at least one temperature sensor, and a thermostat, wherein inside face of the first thermally conductive plate is in physical contact with a plurality of battery cells arranged in a stack in a battery system, and wherein the thermoelectric cooler is in physical contact with outside face of the thermally conductive plate. The thermal management system can further include a second thermally conductive plate, wherein the thermoelectric cooler is physically sandwiched between outside face of the first thermally conductive plate and inside face of the second thermally conductive plate. The thermal management system can further optionally include a heating element to help improve power efficiency, wherein the heating element can be a series of electrical solid conductor elements forming a circuit in order to permit heat generation and transfer of heat to plurality of battery cells. The heating element can be physically sandwiched between the outer wall of the first thermally conductive plate and the thermoelectric cooler, or between the thermoelectric cooler and the inner wall of the second thermally conductive plate, or adherent to the outer wall of the first thermally conductive plate, or adherent to the outer wall of the second thermally conductive plate. The electronic control unit can include a battery management system, a DC to DC converter, a charger, a monitoring unit, and a communication unit, wherein the electronic control unit can be configured to control plurality of battery cells of a battery system.

In an aspect of the present disclosure, there is provided a thermal management system for a battery system comprising a first thermally conductive plate, a thermoelectric cooler, an electronic control unit, at least one temperature sensor; and a thermostat, wherein the inside face of the first thermally conductive plate is in physical contact with a plurality of battery cells arranged in a stack in a battery system, and wherein the thermoelectric cooler is in physical contact with the outside face of the thermally conductive plate. The thermal management system can further include a second thermally conductive plate, wherein the thermoelectric cooler can be physically sandwiched between the outside face of the first thermally conductive plate and the inside face of the second thermally conductive plate. The thermal management system can further optionally include a heating element to improve power efficiency, wherein the heating element can be a series of electrical solid conductor elements forming a circuit in order to permit heat generation and transfer of heat to plurality of battery cells. The heating element can be physically sandwiched between the outer wall of the first thermally conductive plate and the thermoelectric cooler, or between the thermoelectric cooler and the inner wall of the second thermally conductive plate, or adherent to the outer wall of the first thermally conductive plate, or adherent to the outer wall of the second thermally conductive plate. The electronic control unit can include a battery management system, a DC to DC converter, a charger, a monitoring unit, and a communication unit, and wherein the electronic control unit controls plurality of battery cells of a battery system. The plurality of battery cells can be arranged in a stack in a battery system and can be coupled in parallel or in series, wherein the battery cells can be enclosed within a thermally insulating and vibration damping material, and wherein the battery system can be contained in a housing unit, wherein the housing unit can include a fan, a handle, a heat sink, a charge indicator, and a power connector.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE ACCOMPANYING DRAWINGS

The following drawings form part of the present specification and are included to further illustrate aspects of the present disclosure. The disclosure may be better understood by reference to the drawings in combination with the detailed description of the specific embodiments presented herein.

FIG. 1 illustrates an exploded view of proposed portable battery module in accordance with the various embodiments of the present disclosure.

FIG. 2 illustrates an exemplary view of a plurality of battery cells and front face plate in accordance with the various embodiments of the present disclosure.

FIG. 3 illustrates exemplary components of the proposed thermal management system in accordance with the various embodiments of the present disclosure.

FIG. 4 illustrates thermal and vibration insulator used in battery system in accordance with the various embodiments of the present disclosure.

FIG. 5 illustrates battery system in a closed configuration in accordance with the various embodiments of the present disclosure.

FIG. 6 illustrates block diagram of controller unit and control of battery cells in accordance with the various embodiments of the present disclosure.

FIG. 7 illustrates internal structure of electronic controller unit in accordance with the various embodiments of the present disclosure.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Various terms as used herein are shown below. To the extent a term used in a claim is not defined below, it should be given the broadest definition persons in the pertinent art have given that term as reflected in printed publications and issued patents at the time of filing

### DEFINITIONS

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference. The present disclosure is not to be limited in scope by the specific embodiments described herein, which are intended for the purposes of exemplification only. Functionally-equivalent products, compositions, and methods are clearly within the scope of the disclosure, as described herein.

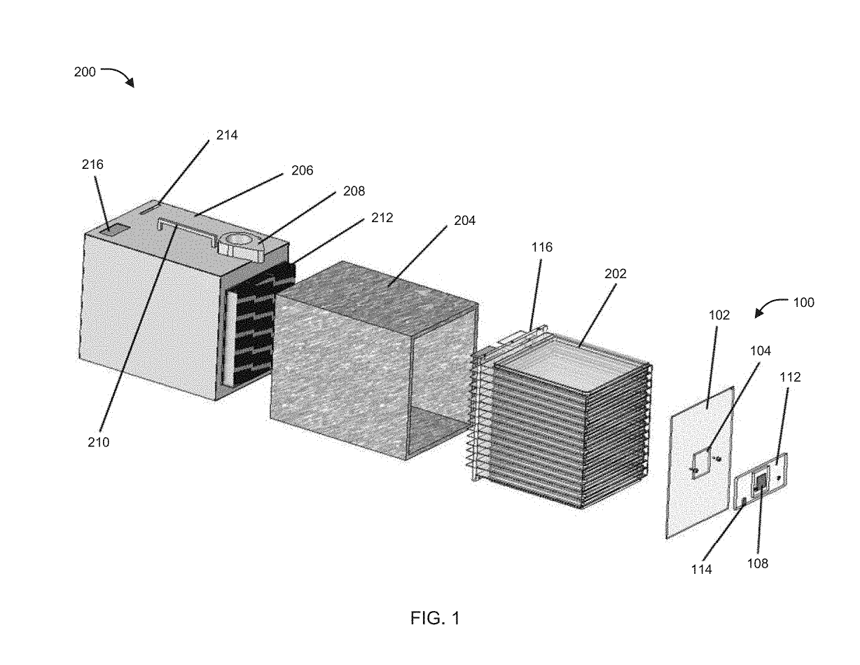

With reference to FIGS. 1-7, in an embodiment of the present disclosure, there is provided a battery system (200) having a plurality of battery cells (202) arranged in a stack, and a thermal management system (100). In an embodiment, the battery cells (202) can be cylindrical cells, button cells, pouch cells, or prismatic cells. In a preferred embodiment, the battery cells (202) are pouch cells. In an embodiment, the pouch cells can be lithium cells with solid electrolytes, and can be configured to allow for maximum design packing efficiency among other cell types. Pouch cells are also cost effective.

In an embodiment, the battery system (200) is essentially a plug and play system whereby it can be used for a variety of end uses such as, but not limited to bicycles, carts, home energy storage, etc. The thermal management system (100) incorporated into the battery system (200) can allow for differential utility of the battery system (200).

In an embodiment, the one or more battery cells (202) can be coupled in parallel. In an alternate embodiment, the plurality of battery cells (202) is coupled in series. In an embodiment, the plurality of battery cells (202) can be attached to at least one fuse or circuit breaker. In an embodiment, the plurality of battery cells (202) can be coupled in parallel and each cell can be attached to a separate fuse or circuit breaker. In another embodiment, the plurality of battery cells (202) can be coupled in series and the series can be attached to a single fuse or circuit breaker.

In an embodiment, the stack of plurality of battery cells (202) can be enclosed within a thermally insulating material (204). In a preferred embodiment, the thermally insulating material (204) can also be a vibration damping material. Enclosure of the battery cells (202) stack within said thermally insulating material (204) provides for control and maintenance of optimum temperature of battery cell function. The vibration damping effect of the material (204) additionally helps in maintaining a secure housing environment and prevents damage to the cells. In an embodiment, the insulating material can be neoprene rubber foam. In yet another embodiment, the material can be a combination of at least two different materials such as Kevlar and neoprene rubber foam. In an embodiment, the material can be multiple layers of neoprene rubber foam or a combination of different materials.

In an embodiment, battery system (200) can be housed in a housing unit (206) that can include a fan (208), a handle (210), a heat sink (212), a charge indicator (214), and a power connector (216). In an embodiment, the housing unit (206) is made of metal or can be made of any other material as suited for a particular purpose, such as galvanized rubber, or plastic. The handle (210) allows for ease of portability and carrying the system. The heat sink (212) can be configured as a multi-fin element made of any thermally conducting material that serves to carry away heat generated by the battery system. An example of a common thermally conducting material is aluminum alloys. Other known materials suitable for heat sink are copper, diamond, composite materials such as copper-tungsten pseudoalloy, AlSiC (silicon carbide in aluminum matrix), Dymalloy (diamond in copper-silver alloy matrix), and E-Material (beryllium oxide in beryllium matrix). In a preferred embodiment, the heat sink is made of aluminum alloy. In an aspect, heat sink (212) can be positioned close to the thermal management system (100) in order to efficiently dissipate heat, wherein the fan (208) allows for faster heat dissipation. The charge indicator (214) allows a user to ascertain the remaining charge of the battery cells (202) of the battery system (200). Alternatively, it also allows the user to determine remaining charge. The power connector (216) allows for charging of the battery cells. The power connector is suitable to receive energy from an electrical source.

In an embodiment, there is provided a thermal management system (100) for a battery system (200), wherein the thermal system (100) can include a first thermally conductive plate (102), a thermoelectric cooler (104), an electronic control unit (106), at least one temperature sensor (110), and a thermostat (114), wherein the inside face of the first thermally conductive plate (102) is in physical contact with a plurality of battery cells (202) arranged in a stack in a battery system (200), and wherein the thermoelectric cooler (104) is in physical contact with the outside face of the thermally conductive plate (102). In an embodiment, the thermal management system (100) can further include a second thermally conductive plate (112).

In an embodiment, the first thermally conductive plate (102) functions to transfer heat generated by the battery cells (202) enclosed within the insulating material (204) to outside, wherein the transfer can be further facilitated by the heat sink (212) and the fan (208) as described. In an alternate embodiment, the first thermally conductive plate (102) also functions to keep the battery cell compartment at optimum temperature during use.

In an embodiment, the thermoelectric cooler (104) is also commonly known as a Peltier device, Peltier heat pump or solid state refrigerator. It can be used for heating or cooling purposes, though typically it is used for cooling. A thermoelectric cooler can be implemented to maintain a stable temperature to within ±0.01° C. of the desired temperature. In an embodiment, the thermoelectric cooler (104) can be physically sandwiched between the outside face of the first thermally conductive plate (102) and the inside face of the second thermally conductive plate (112). In an embodiment, the cold side of the thermoelectric cooler (104) is in physical contact with the outside wall of the first thermally conductive plate (102) while the hot side of the thermoelectric cooler (104) is in physical contact with the inside face of the second thermally conductive plate (112). In an embodiment, the inside face of the second thermally conductive plate (112) has a slot design for the thermoelectric cooler (104) to fit. In an embodiment, an additional utility of the second thermally conductive plate (112) is to enhance the heat transfer characteristics of the thermoelectric cooler (104) by providing a bigger thermally conductive area. In an embodiment, multiple thermoelectric coolers may be cascaded for achieving higher rate of heat transfer. In an embodiment, the flow of current through the thermoelectric cooler (104) is reversible in order to elevate the temperature of the battery cell compartment, particularly when the system (200) is used in cold exterior conditions.

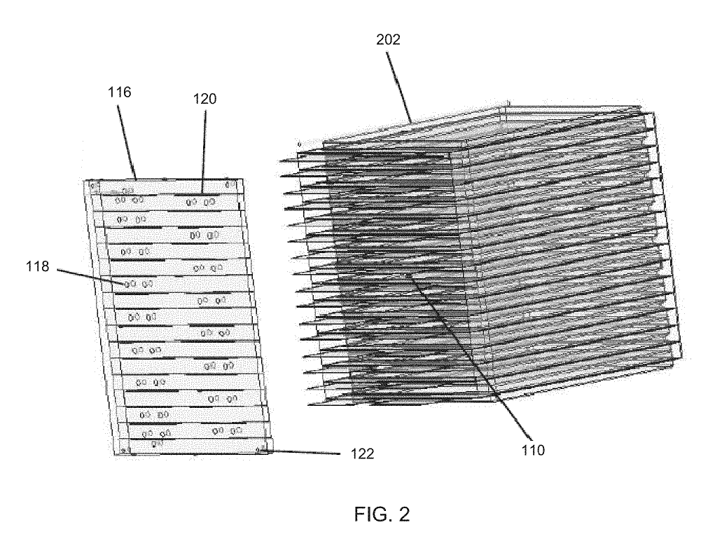

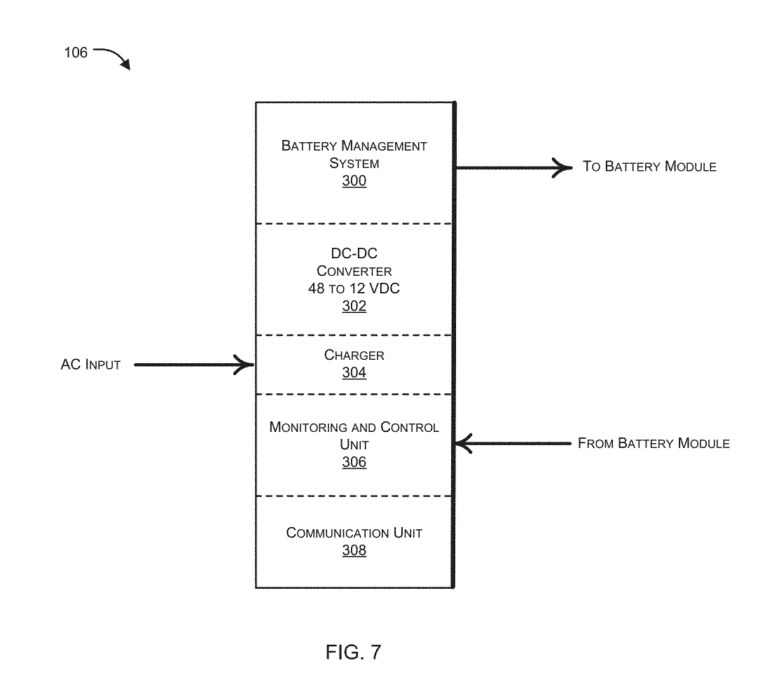

In an embodiment, the temperature sensor (110) (see FIG. 2) can be positioned on the inside wall of the first thermally conductive plate 102. The temperature sensor (110) detects ambient temperature of the battery cells (202) enclosure, and communicates with the thermoelectric cooler (104) via the electronic controller unit (106) (see FIG. 7) in order to maintain a working temperature range within the battery cells (202) enclosure. In an embodiment, a second temperature sensor is positioned between the front plate (116) and front face of the plurality of battery cells (202).

In an embodiment, the thermostat (114) functions as a safety circuit inline breaker to protect against thermal runaway. The temperature sensor(s) (110) communicates with the electronic controller unit (106). In an embodiment, the thermostat (114) functions independently to regulate the temperature of the battery cells enclosure. In an embodiment, the thermostat (114) helps the electronic control unit (106) from thermal runaway and protects the thermal management system (100) from overheating.

In an embodiment, the thermal management system (100) further optionally comprises a heating element (108) to improve power efficiency, wherein said heating element (108) is a series of electrical solid conductor elements forming a circuit in order to permit heat generation and transfer of heat to plurality of battery cells (202). In an embodiment, the heating element (108) can be made of copper. In an embodiment, the heating element (108) can be physically sandwiched between the outer wall of the first thermally conductive plate (102) and the cold side of the thermoelectric cooler (104). In an alternate embodiment, the heating element (108) can be physically sandwiched between the thermoelectric cooler (104) and the inner wall of the second thermally conductive plate (112). In another embodiment, the heating element (108) can be adherent to the outer wall of the first thermally conductive plate (102). In another embodiment, the heating element (108) can be adherent to the outer wall of the second thermally conductive plate (112). In an embodiment, the thermal management system as described herein has one heating element. In an alternate embodiment, the thermal management system (100) as described herein has multiple heating elements adhered or positioned at different places as described herein. In an embodiment, the heating element (108) aids to improve the efficiency of the thermal management system (100).

In an embodiment, the electronic control unit (106) comprises a battery management system (300), a DC to DC converter (302), a charger (304), a monitoring unit (306), and a communication unit (308), and wherein the electronic control unit (106) controls the plurality of battery cells (202) of a battery system (200). In an embodiment, the electronic control unit (106) independently controls each of the plurality of battery cells (202) when the cells are coupled in parallel to each other. In an embodiment, the electronic control unit (106) singly controls the plurality of battery cells (202) when the cells are coupled in series. In an embodiment, the temperature sensor(s) (110) communicate with the electronic control unit (106) to maintain optimum temperature range of the battery cells. In an embodiment, the electronic control unit (106) communicates with the thermoelectric cooler (104) to apply correct voltage to maintain optimum temperature range of the battery cells. In an embodiment, the thermoelectric cooler (104) and the temperature sensor (110) communicate with each other via the electronic control unit (106) to maintain optimum temperature range of the battery cells. In an embodiment, the temperature sensor (110), thermostat (114), and the thermoelectric cooler (104) communicate with each other through the electronic control unit (106) to regulate temperature range of the battery cells enclosure.

In an exemplary embodiment, FIG. 1 shows an exploded view of the portable battery module, in accordance with the various embodiments of the present disclosure. Briefly, as seen in FIG. 1, the portable light weight battery system (200) is enclosed within a metal housing (206). Visible at the exterior of the metal housing (206) are the following: a fan (208) to dissipate heat and aid air circulation, a handle (210) for carrying the case, a charge indicator (214) to aid visual communication of battery cells status such as charging time, time to full charge, etc., a power port (216) to enable charging of the battery cells (202), and a heat sink (212). The heat sink functions to dissipate the heat generated by the plurality of battery cells. Within the metal housing (206) is contained a plurality of battery (pouch) cells (202) arranged in a stack and coupled in parallel to each other. There is some space provided in between each pouch cell to allow for expansion during charging cycles. At the front end of the plurality of cells, there is provided a plate (116) (preferably durable plastic insulating material) which holds the plurality of pouch cells in place and also connects the individual terminals. The plate (116) also has individual fuses (not shown for brevity), each of which forms a circuit with a single battery (pouch) cell. The battery (pouch) cells are enclosed within a thermally insulating and vibration resistant material (204) such as neoprene rubber foam. At the back of the stack of cells is a thermally conductive metal plate (102), the inside face of which is in physical contact with each of the battery (pouch) cells. On the outside face of the plate (102) is attached a second thermally conductive plate (112) which is of smaller dimension than the first thermally conductive plate (102). Sandwiched in between the first (102) and the second (112) thermally conductive plate is a thermoelectric cooler (104). On the outside face of the second plate (112) is adhered a single heating element (108). The heating element (108) is a series of electrical solid conductor elements forming a circuit in order to permit heat generation and transfer of heat to plurality of battery cells (202). The heating element (108) serves to further enhance the power efficiency of the thermoelectric cooler (104). The heating element size and shape can be varied depending upon the end user functions. There is also a thermostat (114) and a temperature sensor (110) (not shown for brevity), each of which work independently or in conjunction with each other to regulate the temperature of the cells. The thermal management system comprising the plates (102, 112), thermoelectric cooler (104), heating element (108), temperature sensor(s) (110), and thermostat (114) are controlled electronically by an electronic control unit (106).

In an exemplary embodiment, FIG. 2 shows the view of the plurality of battery cells (202) and the front face plate (116). Briefly, as shown in FIG. 2, (202) represents the plurality of pouch cells stacked lightly on top of each other to allow for expansion. The temperature sensor (110) is in close proximity to the stack. The front plate (116), which is made of a durable plastic insulating non-conductive material. The battery (pouch) cells have tabs which need to be connected to other tabs in parallel or series, preferably parallel in order to achieve higher combinatorial voltage output. The plate (116) has holes with brass inserts (118) and tab slots (120). The battery cell tabs are inserted through the tab slots (120) and are secured to the plate (116) by screws which fit on the brass inserts (118). The plate (116) also has 4 holes, 1 each in each corner (122) for securing the plate to the metal housing (206). It is also contemplated that the plate (116) is snap-on.

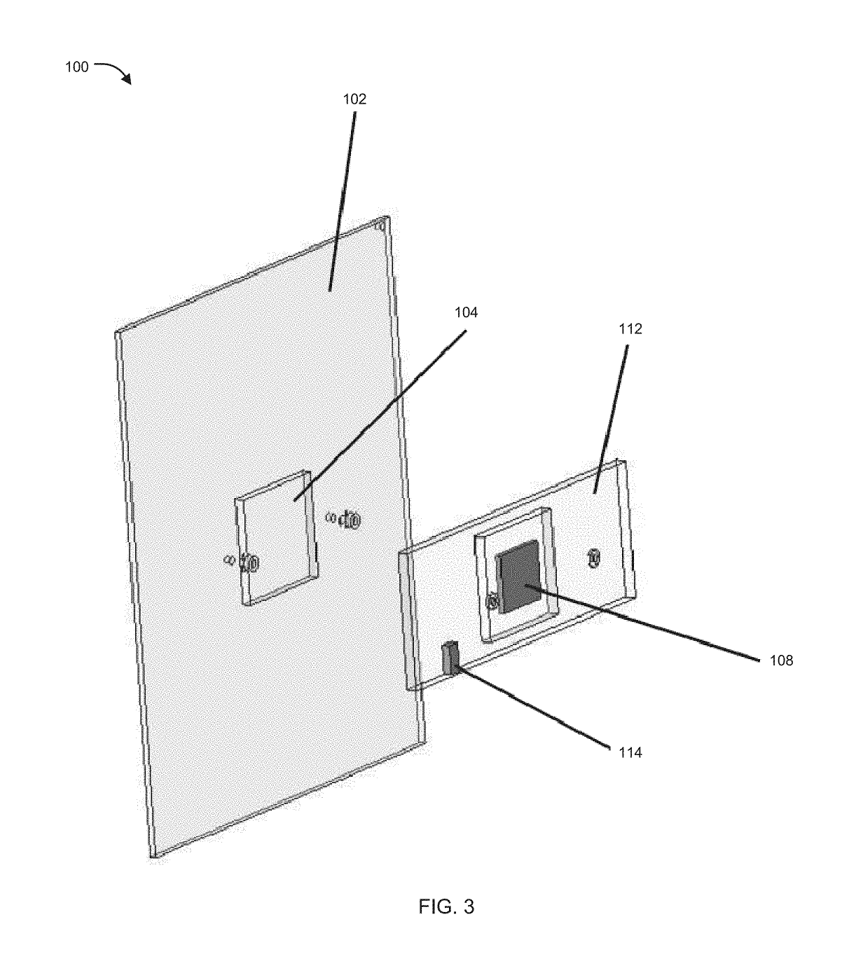

In an exemplary embodiment, FIG. 3 shows the chief components of the thermal management system. Briefly, as shown in FIG. 3, the thermally conductive metal plate (102) is for heating or cooling the battery cells. The inside face of the plate (102) is in contact with the stack of battery cells. On the outside face of the plate (102) is attached a second thermally conductive metal plate (112) which serves a dual function of housing a thermoelectric cooler (104) and heat dissipation. The dimensions of the second plate (112) are smaller than that of the first plate (102). The thermoelectric cooler (104) is sandwiched between the outside face of the first plate (102) and the inside face of the second plate (112). The inside face of the second plate (112) has a slot in which the thermoelectric cooler (104) sits. The cold side of the thermoelectric cooler (104) is in contact with the outside face of the first plate (102), while the hot side is in contact with the inside face of the second plate (112). The thermoelectric cooler helps to maintain the temperature within the battery cells enclosure. A thermoelectric cooler owing to its small size and lightweight construction allows the same to be embedded within the battery housing (200). Temperature range control of battery cells stack is necessary as sustained higher temperature leads to shorter battery cell life span and charge capacity. The outside face of the second plate (112) comprises an adherent heating element (108), which is essentially a series of electrical solid conductor elements forming a circuit in order to permit heat generation and further increase the power efficiency of the thermoelectric cooler (104). The heating element also allows for heating of the battery unit when used in cold exterior temperatures. The thermal management system also comprises a thermostat and temperature sensor(s) to ensure that the working temperature range of the battery unit is maintained. The various components as described are controlled electronically by an electronic control unit (106).

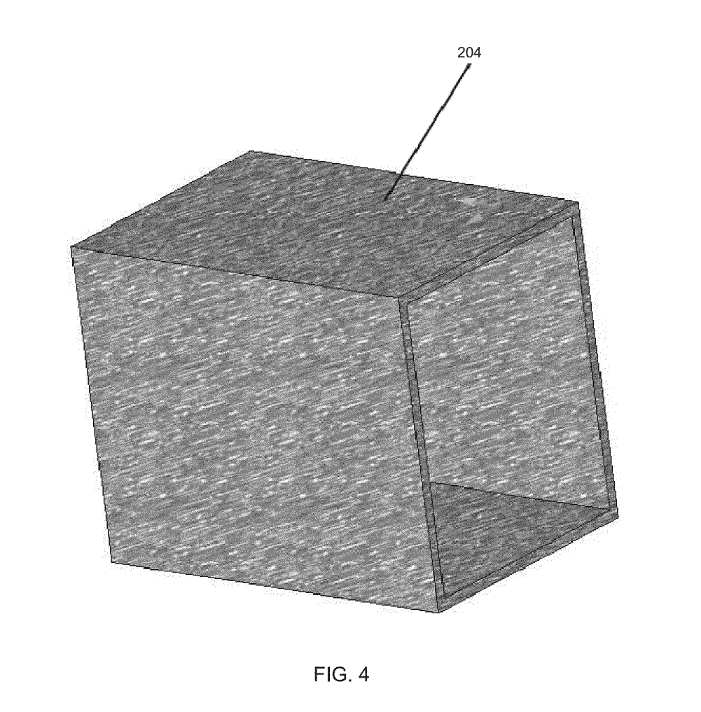

In an exemplary embodiment, FIG. 4 shows thermal and vibration insulator used in the battery system (200) of the present disclosure. In brief, as show in FIG. 4, the thermal and vibration insulating material (204) is made preferably of neoprene rubber foam, and encloses the battery cells stack (202). The enclosure has two open ends, namely, a front end, and a back end. The plate (116) is affixed to the front end, while first plate (102) of the thermal management system (100) is affixed to the back end.

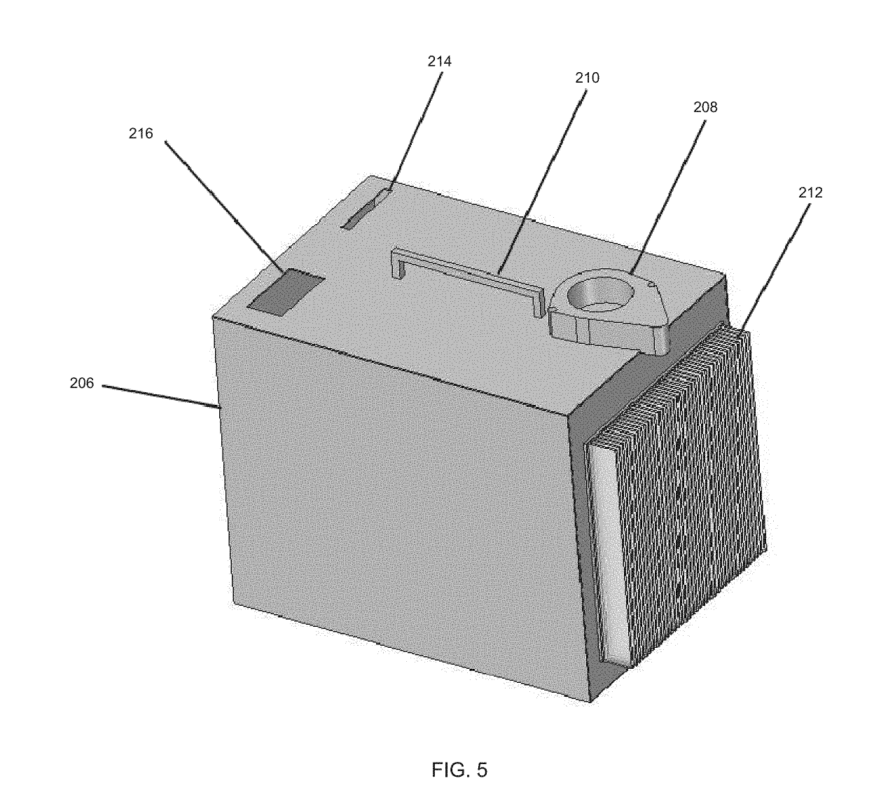

In an exemplary embodiment, FIG. 5 shows the battery system (200) in closed configuration. As discussed previously and as shown in FIG. 1, the various exterior parts of the battery system (200) are shown in FIG. 5. The housing unit (206) is a metal casing, which has a handle (210), a fan (208) near the rear for forced air cooling and dissipating heat, a charge indicator (214), a power port (216) for charging, and a heat sink (212), which comprises multiple fins for heat dissipation. The compact battery system (200) can be used in electric cars, hybrid cars, neighborhood electric vehicles, electric bikes and scooters, and as a home energy storage device. The electronic control unit (106) is also enclosed within the housing (206) which allows for management of the various components of the thermal management system which is integrated within the battery system (200). The control unit (106) allows for monitoring and regulating voltage, current, temperature, etc.

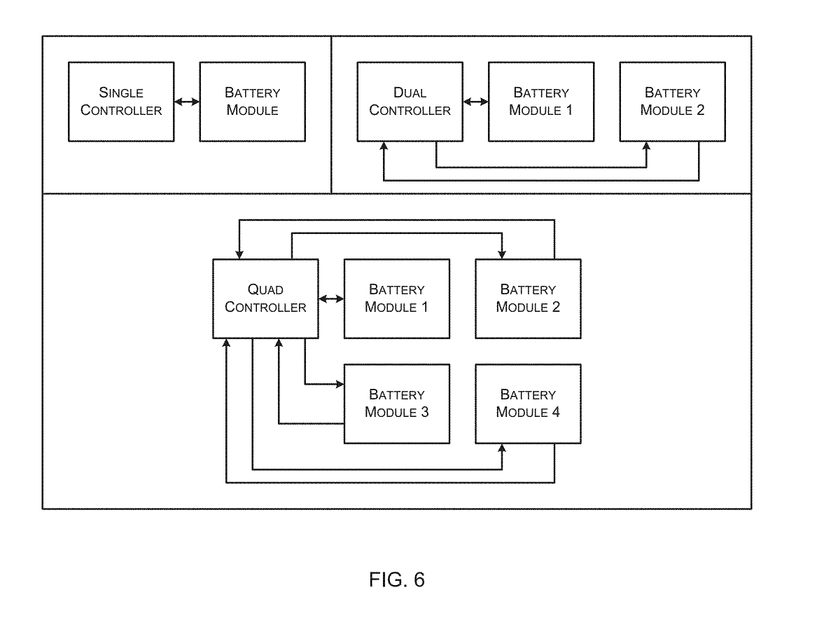

In an exemplary embodiment, FIG. 6 shows the block diagram of the controller unit (106) and control of the battery cells (202). As shown in FIG. 6, each battery cell is directly controlled by the controller. This allows for individual battery cells to be regulated in terms of discharge and charging limits, and provide balance when connected in series.

In an exemplary embodiment, FIG. 7 shows the internal structure of the electronic controller unit (106). The controller unit essentially comprises a battery management system (300), a DC to DC converter (302), charger (304), monitoring and control unit (306), and a communication unit (308). AC power is fed to the charger port (304). The DC to DC converter provides lower voltage required for thermal controller and battery management system. The battery management system and the monitoring and control unit regulate charging and discharging of the battery cells in part by setting voltage limits. The communication unit interacts with the main controller wirelessly or by wire to single/dual/quad controller to exchange information such as charge, number of cycles, temperature, etc.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

Although the subject matter has been described in considerable detail with reference to certain preferred embodiments thereof, other embodiments are possible.

### Advantages of the Present Invention

The present disclosure provides a battery system with an integrated light weight and compact thermal management system.

The present disclosure provides a battery system with an integrated light weight and compact thermal management system that allows for portability and varied functionality of the battery system.

The present disclosure provides a battery system with an integrated light weight and compact thermal management system is easily swappable and includes its own power and thermal management system, thus allowing interoperability among various devices

1. A battery system comprising:
a plurality of battery cells arranged in a stack; and
a thermal management system.

2. The system as claimed in claim 1, wherein said plurality of battery cells is coupled in parallel or in series.

3. The system as claimed in claim 1, wherein said plurality of battery cells is attached to at least one fuse or circuit breaker.

4. The system as claimed in claim 1, wherein plurality of battery cells is enclosed within a thermally insulating and vibration damping material.

5. The system as claimed in claim 1, wherein said battery system is contained in a housing unit, said housing unit comprising a fan, handle, heat sink, charge indicator, and power connector.

6. The system as claimed in claim 1, wherein said thermal management system comprises: a first thermally conductive plate, a thermoelectric cooler, an electronic control unit, at least one temperature sensor, and a thermostat, wherein the inside face of the first thermally conductive plate is in physical contact with a plurality of battery cells arranged in a stack in a battery system, and said thermoelectric cooler is in physical contact with the outside face of the thermally conductive plate.

7. The system as claimed in claim 6, wherein said thermal management system further comprises a second thermally conductive plate, wherein said thermoelectric cooler is physically sandwiched between the outside face of the first thermally conductive plate and the inside face of the second thermally conductive plate.

8. The system as claimed in claim 6, wherein said thermal management system further optionally comprising a heating element to improve power efficiency, wherein said heating element is a series of electrical solid conductor elements forming a circuit in order to permit heat generation and transfer of heat to plurality of battery cells.

9. The system as claimed in claim 8, wherein said heating element is physically sandwiched between the outer wall of the first thermally conductive plate and the thermoelectric cooler, or between the thermoelectric cooler and the inner wall of the second thermally conductive plate, or adherent to the outer wall of the first thermally conductive plate, or adherent to the outer wall of the second thermally conductive plate.

10. The system as claimed in claim 6, wherein said electronic control Unit comprises: battery management system, DC to DC converter, charger, monitoring unit, and communication unit, and wherein said electronic control unit controls plurality of battery cells of a battery system.

11. A thermal management system for a battery system comprising:
a first thermally conductive plate;
a thermoelectric cooler;
an electronic control unit;
at least one temperature sensor; and
a thermostat,
wherein the inside face of the first thermally conductive plate is in physical contact with a plurality of battery cells arranged in a stack in a battery system, and said thermoelectric cooler is in physical contact with the outside face of the thermally conductive plate.

12. The system as claimed in claim 11, further comprising a second thermally conductive plate, wherein said thermoelectric cooler is physically sandwiched between the outside face of the first thermally conductive plate and the inside face of the second thermally conductive plate.

13. The system as claimed in claim 11, further optionally comprises a heating element to improve power efficiency, wherein said heating element is a series of electrical solid conductor elements forming a circuit in order to permit heat generation and transfer of heat to plurality of battery cells.

14. The system as claimed in claim 13, wherein said heating element is physically sandwiched between the outer wall of the first thermally conductive plate and the thermoelectric cooler, or between the thermoelectric cooler and the inner wall of the second thermally conductive plate, or adherent to the outer wall of the first thermally conductive plate, or adherent to the outer wall of the second thermally conductive plate.

15. The system as claimed in claim 11, wherein said electronic control unit comprises: battery management system, DC to DC converter, charger, monitoring unit, and communication unit, and wherein said electronic control unit controls plurality of battery cells of a battery system

16. The system as claimed in claim 11, wherein said plurality of battery cells arranged in a stack in a battery system are coupled in parallel or in series, wherein said battery cells are enclosed within a thermally insulating and vibration damping material, and wherein said battery system is contained in a housing unit, said housing unit comprising a fan, handle, heat sink, charge indicator, and power connector.
